(19) United States
(12) Patent Application Publication
(10) Pub. No.: US 2026/0229558 A1
(43) Pub. Date: Aug. 6, 2026

(54) FUEL CELL VEHICLE AND A METHOD OF COOLING THE SAME

(71) Applicants: HYUNDAI MOTOR COMPANY, Seoul (KR); KIA CORPORATION, Seoul (KR)

(72) Inventor: Dong Keon Lee, Hwaseong-si (KR)

(73) Assignees: HYUNDAI MOTOR COMPANY, Seoul (KR); KIA CORPORATION, Seoul (KR)

(21) Appl. No.: 19/311,591

(22) Filed: Aug. 27, 2025

(30) Foreign Application Priority Data
Feb. 4, 2025 (KR) 10-2025-0013768

(51) Int. Cl. H01M 8/04007; H01M 8/04029; H01M 8/04119; H01M 8/0432; H01M 8/04701; H01M 8/04746

(52) U.S. Cl. CPC H01M 8/04074; H01M 8/04029; H01M 8/04164; H01M 8/04358; H01M 8/04723; H01M 8/04768; H01M 2250/20

(57) ABSTRACT

A fuel cell vehicle includes a fuel cell configured to discharge product water as a by-product of power generation, a condensate generation unit configured to generate condensate having a lower temperature than the product water, a radiator configured to dissipate heat from cooling water having cooled the fuel cell, a nozzle configured to allow at least one of the product water, the condensate, or mixed water obtained by mixing the product water and the condensate to flow to the radiator in response to a control signal, and a controller configured to generate the control signal in accordance with the degree of cooling required for the fuel cell.

### This application claims the benefit of priority to Korean Patent Application No. 10-2025-0013768, filed on Feb. 4, 2025, which is hereby incorporated by reference as if fully set forth herein.

### BACKGROUND OF THE DISCLOSURE

### Field of the Disclosure

Embodiments relate to a fuel cell vehicle and a method of cooling the same.

### Discussion of the Related Art

In order to cope with climate change, eco-friendly vehicles for reduction of carbon emissions are actively being developed around the world. Because most large trucks travel a long distance and require high output, diesel engines are generally mounted in large trucks. Such a diesel engine generates emissions, such as NOx, PM, and carbon dioxide, during fuel combustion, which accelerates global warming. In order to reduce carbon emissions caused by these driving characteristics of trucks, research on eco-friendly vehicles using hydrogen is being actively conducted around the world.

A fuel cell electric vehicle (FCEV) (hereinafter referred to as a “fuel cell vehicle”) is a vehicle that uses electrical energy generated through a chemical reaction between hydrogen and oxygen as an energy source. In the case of a fuel cell vehicle, no carbon emissions are produced, and the fuel may be easily stored and moved. In addition, a fuel cell vehicle has a shorter charging time and a longer range than other types of eco-friendly vehicles. For these reasons, hydrogen is suitable as a fuel for large trucks. However, a fuel cell vehicle having the above advantages has problems to be solved.

FIG. 1A is a graph showing comparison between management temperatures required by an internal combustion engine C1 and a fuel cell C2, and FIG. 1B is a graph showing comparison between cooling requirements of the internal combustion engine C1 and the fuel cell C2.

Referring to FIG. 1A, the temperature of the internal combustion engine C1 needs to be managed to fall within a range of 110° C. to 120° C., and the temperature of the fuel cell C2 needs to be managed to fall within a range of 70° C. to 80° C. A difference between the management temperature of the fuel cell C2 and an outside temperature of a vehicle is smaller than a difference between the management temperature of the internal combustion engine C1 and an outside temperature of a vehicle. Therefore, if a cooling module for use in the internal combustion engine C1 is applied to the fuel cell C2, cooling performance may be degraded. Further, unlike the internal combustion engine C1, the fuel cell C2 has no exhaust system. Therefore, in the case of the fuel cell C2, about 50% of input energy is discharged as heat, and accordingly, a cooling requirement of the fuel cell is high, as shown in FIG. 1B. In consideration thereof, in the case of a fuel cell vehicle equipped with the fuel cell C2, the size and the number of cooling modules for cooling a cell stack of the fuel cell may be increased relative to the size and number of cooling modules for an internal combustion engine.

Furthermore, as a fuel cell vehicle is motorized, it is necessary to cool not only a fuel cell but also a motor, a power electric or power electronics (PE) module, an automatic transmission (ATM), and a high-voltage battery. Numerically, the number of parts to be cooled in a vehicle equipped with the fuel cell C2 (e.g., twenty to thirty) is about five times as large as the number of parts to be cooled in a vehicle equipped with the internal combustion engine C1 (e.g., four to six). In the case of a fuel cell vehicle, in which the number of parts to be cooled is relatively large, there are limits on the extent to which the size of a cooling module may be increased due to the limited size of the fuel cell vehicle. Further, considering a passenger compartment, a storage space, and a payload, the size of the space occupied by a cooling system in a fuel cell vehicle is at least three or four times as large as that in a vehicle equipped with an internal combustion engine, e.g., a diesel engine. Therefore, research with the goal of maximizing cooling performance in a limited space in a fuel cell vehicle is underway.

### SUMMARY OF THE DISCLOSURE

Accordingly, embodiments of the present disclosure are directed to a fuel cell vehicle and a method of cooling the same that substantially obviate one or more problems due to limitations and disadvantages of the related art.

Embodiments of the present disclosure provide a fuel cell vehicle having excellent and efficient cooling performance and a method of cooling the same.

However, the objects to be accomplished by the embodiments of the present disclosure are not limited to the above-mentioned objects, and other objects not mentioned herein should be clearly understood by those of ordinary skill in the art from the following description.

Additional advantages, objects, and features of the disclosure are set forth in part in the description which follows and in part should become apparent to those having ordinary skill in the art upon examination of the following description or may be learned from practice of the disclosure. The objectives and other advantages of the disclosure may be realized and attained by the structure particularly pointed out in the written description and claims hereof as well as the appended drawings.

A fuel cell vehicle according to an embodiment may include a fuel cell including a cell stack configured to discharge product water as a by-product of power generation, a condensate generation unit configured to generate condensate having a lower temperature than the product water, a radiator configured to dissipate heat from cooling water having cooled the fuel cell, a nozzle configured to allow at least one of the product water, the condensate, or mixed water obtained by mixing the product water and the condensate to flow to the radiator in response to a control signal, and a controller configured to generate the control signal in accordance with the degree of cooling required for the fuel cell.

In an example, the nozzle may include a first nozzle configured to allow the condensate or the mixed water to flow to an upper part of the radiator and a second nozzle configured to allow the mixed water to flow to a lower part of the radiator.

In an example, the upper part of the radiator may correspond to an area of the radiator including 30% to 100% of the overall height of the radiator.

In an example, the first nozzle may allow the condensate or the mixed water to flow through an open area of the radiator extending in a horizontal direction, and the second nozzle may allow the mixed water to flow through an open area of the radiator extending in a vertical direction.

In an example, the first nozzle may include one or more first nozzles based on the amount of heat generated from the cell stack, the one or more first nozzle(s) may have a length proportional to the number of fins and the number of tubes of the radiator, and the second nozzle may include one or more second nozzles based on the number of tubes of the radiator.

In an example, the fuel cell vehicle may further include a first reservoir configured to store the product water and a second reservoir configured to store the condensate.

In an example, the fuel cell vehicle may further include a mixed water generation unit configured to mix the product water and the condensate to generate the mixed water having a lower temperature than the product water and a higher temperature than the condensate.

In an example, the mixed water generation unit may include a first valve configured to regulate the flow rate of the product water discharged from the first reservoir, a second valve configured to regulate the flow rate of the condensate discharged from the second reservoir, and a third reservoir configured to store, as the mixed water, water obtained by mixing the product water having passed through the first valve and the condensate having passed through the second valve.

In an example, the fuel cell vehicle may further include a third valve configured to regulate the flow rate of the condensate discharged from the second reservoir and a fourth reservoir configured to store the condensate having passed through the third valve.

In an example, the fuel cell vehicle may further include a first sensor configured to sense at least one of the temperature or the level of the mixed water stored in the third reservoir and a second sensor configured to sense at least one of the temperature or the level of the condensate stored in the fourth reservoir, and the controller may generate the control signal using a result of the sensing by at least one of the first sensor or the second sensor.

In an example, the third reservoir may be located at a higher position than the nozzle, and the fuel cell vehicle may further include a fourth valve configured to discharge the mixed water stored in the third reservoir to the nozzle.

In an example, the third reservoir may be located at a lower position than the nozzle, and the fuel cell vehicle may further include a pump configured to discharge the mixed water stored in the third reservoir to the nozzle.

In an example, the fourth reservoir may be located at a lower position than the nozzle, and the fuel cell vehicle may further include a pump configured to discharge the mixed water stored in the fourth reservoir to the nozzle.

In an example, the fuel cell vehicle may further include a fifth valve configured to allow or interrupt the supply of the condensate stored in the fourth reservoir to the nozzle.

In an example, the fuel cell vehicle may further include a fan configured to control at least one of an air flow to the radiator or an air flow from the radiator and a third sensor disposed between the radiator and the fan and configured to sense the amount of product water, condensate, or mixed water having passed through the radiator, and the controller may control the revolutions per minute of the fan using a result of the sensing by the third sensor.

In an example, the radiator may include a first radiator and a second radiator disposed behind the first radiator, and the third sensor may be disposed between the second radiator and the fan.

In an example, the fuel cell vehicle may further include a condenser disposed in front of the radiator.

According to another embodiment, a method of cooling a fuel cell vehicle including a fuel cell configured to discharge product water as a by-product of power generation, a condensate generation unit configured to generate condensate having a lower temperature than the product water, and a radiator configured to dissipate heat from cooling water having cooled the fuel cell may include providing mixed water obtained by mixing the product water and the condensate to an upper part and a lower part of the radiator based on the degree of cooling required for the fuel cell being less than a maximum degree and providing the condensate to the upper part of the radiator and providing the mixed water to the lower part of the radiator based on the degree of cooling required for the fuel cell being the maximum degree.

In an example, the mixed water or the condensate may be provided to the upper part of the radiator so as to travel through an open area extending in a horizontal direction, and the mixed water may be provided to the lower part of the radiator so as to travel through an open area extending in a vertical direction.

In an example, the fuel cell vehicle may further include a fan configured to control at least one of an air flow to the radiator or an air flow from the radiator, and the method may further include controlling the revolutions per minute of the fan in inverse proportion to the amount of product water, condensate, and mixed water having passed through the radiator.

In an example, based on the fuel cell vehicle being driven at a high speed or on a hill, the degree of cooling required may be determined to be maximum degree.

In an example, the method may further include determining whether the amount of condensate is greater than or equal to a threshold amount based on the degree of cooling required for the fuel cell being the maximum degree, providing the mixed water to the upper part of the radiator based on the amount of condensate being less than the threshold amount, and providing the condensate to flow to the upper part of the radiator based on the amount of condensate being greater than or equal to the threshold amount.

It is to be understood that both the foregoing general description and the following detailed description of the present disclosure are provided by way of example and are explanatory in nature and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1A is a graph showing comparison between management temperatures required by an internal combustion engine and a fuel cell;

FIG. 1B is a graph showing comparison between cooling requirements of an internal combustion engine and a fuel cell;

FIG. 2 is a block diagram of a fuel cell vehicle according to an embodiment;

FIG. 3 is a front view of a radiator shown in FIG. 2; and

FIG. 4 is a flowchart for explaining a method of cooling the fuel cell vehicle according to an embodiment.

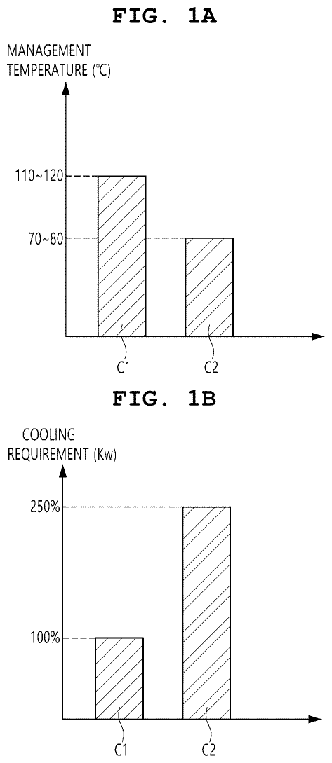

### DETAILED DESCRIPTION OF THE DISCLOSURE

The present disclosure is described more fully hereinafter with reference to the accompanying drawings, in which various embodiments are shown. The examples, however, may be embodied in many different forms, and should not be construed as being limited to the embodiments set forth herein. Rather, these embodiments are provided to make this disclosure more thorough and complete, and to more fully convey the scope of the disclosure to those of ordinary skill in the art.

It should be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

Hereinafter, a fuel cell vehicle 100 according to an embodiment of the present disclosure is described with reference to the accompanying drawings.

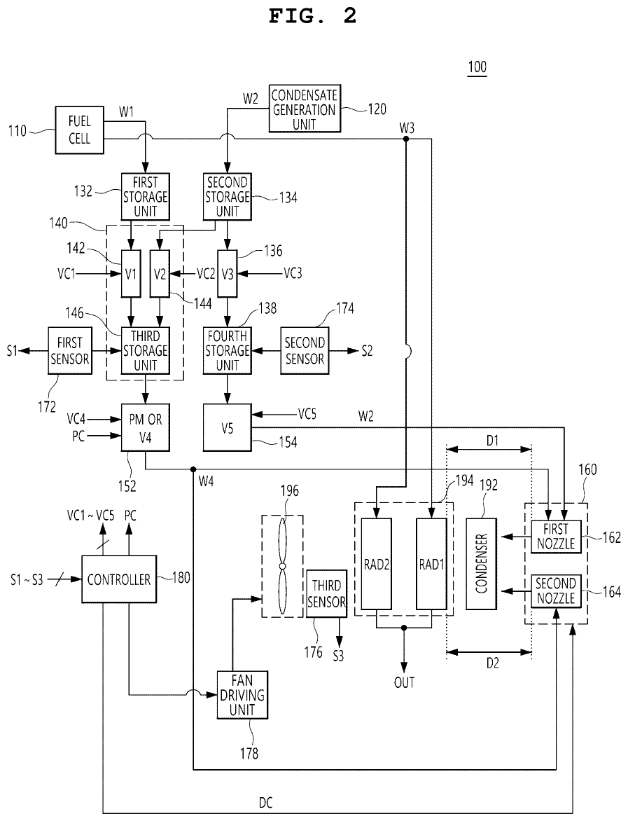

FIG. 2 is a block diagram of a fuel cell vehicle 100 according to an embodiment of the present disclosure.

The fuel cell vehicle 100 shown in FIG. 2 may include a fuel cell 110, a condensate generation unit 120, a nozzle 160, a radiator 194, and a controller 180.

The fuel cell 110 may be, for example, a polymer electrolyte membrane fuel cell (or a proton exchange membrane fuel cell) (PEMFC), which has been studied most extensively as a power source for driving vehicles. However, the embodiments are not limited to any specific form of the fuel cell 110.

As a result of generation of power by the fuel cell 110, water (hereinafter referred to as “product water”) W1 may be discharged from the fuel cell. The temperature of the product water may be about 60° C., for example, 57° C.-58° C., or may be 60° C. or higher. The product water may be discharged at a rate of 1-2 liters per minute.

In the fuel cell 110, hydrogen, which is a fuel, may be supplied to a fuel electrode through a first separator, and air containing oxygen, which is an oxidizer, may be supplied to an air electrode through a second separator.

The hydrogen supplied to the fuel electrode is decomposed into hydrogen ions (protons) (H+) and electrons (e−) by a catalyst. The hydrogen ions alone may be selectively transferred to the air electrode through a polymer electrolyte membrane, and at the same time, the electrons may be transferred to the air electrode through gas diffusion layers, which are conductors, and the separators. In order to realize the above operation, a catalyst layer may be applied to each of the fuel electrode and the air electrode. The movement of the electrons described above causes the electrons to flow through an external conductive wire, thus generating current. The fuel cell 110 may generate power due to electrochemical reaction between hydrogen, which is a fuel, and oxygen contained in air.

In the air electrode, the hydrogen ions supplied thereto through the polymer electrolyte membrane and the electrons transferred thereto through the separators meet oxygen contained in the air supplied thereto, thereby causing a reaction that generates product water.

The condensate generation unit 120 may condense gaseous vapor to generate condensate W2. The condensate W2 may be discharged from a compressor of an air-conditioner of the vehicle in the summer. However, the embodiments are not limited to any specific method of generating the condensate W2. The condensate W2 has a lower temperature than the product water W1, and is discharged in a smaller amount or quantity than the product water W1. For example, the temperature of the condensate W2 may be 20° C.-25° C., and may be discharged at a rate of 0.5-0.6 liters per minute.

The radiator 194 is a type of heat sink or heat exchanger that dissipates heat from the cooling water W3, the cooling water W3 having cooled the fuel cell 110, to the outside and supplies the cooling water W3 from which heat has been dissipated back to the fuel cell 110 through an output terminal OUT. As shown in the drawings, the radiator 194 may include a first radiator RAD1 and a second radiator RAD2. The first radiator RAD1 is disposed in front of the second radiator RAD2, and the second radiator RAD2 is disposed behind the first radiator RAD1. According to another embodiment, the radiator 194 may include only one of the first and second radiators RAD1 and RAD2.

In addition, the fuel cell vehicle 100 according to the embodiment may further include a condenser (or a compressor) 192. The condenser 192 may be disposed in front of the radiator 194 in order to facilitate heat exchange of the air-conditioner. However, the embodiments are not limited to any specific position at which the condenser 192 is disposed.

Hereinafter, for convenience of description, the fuel cell vehicle 100 is described as not including the condenser 192.

In addition, the fuel cell vehicle 100 according to the embodiment may further include a radiator fan (hereinafter referred to as a “fan”) 196 and a fan driving unit 178. The fan 196 serves to control the air flow to the radiator 194 and/or the air flow from the radiator 194. The fan driving unit 178 serves to drive the fan 196 and regulate the revolutions per minute (RPM) of the fan 196 under the control of the controller 180.

However, the embodiments are not limited as to the type and number of radiators 194 and the presence/absence and form of the fan 196.

The nozzle 160 allows at least one of the condensate W2 or water W4 obtained by mixing the product water W1 and the condensate W2 (hereinafter referred to as “mixed water”) to flow to the radiator 194.

The nozzle 160 may include first and second nozzles 162 and 164. The first nozzle 162 allows the condensate W2 or the mixed water W4 to flow to an upper part of the radiator 194, and the second nozzle 164 allows the mixed water W4 to flow to a lower part of the radiator 194.

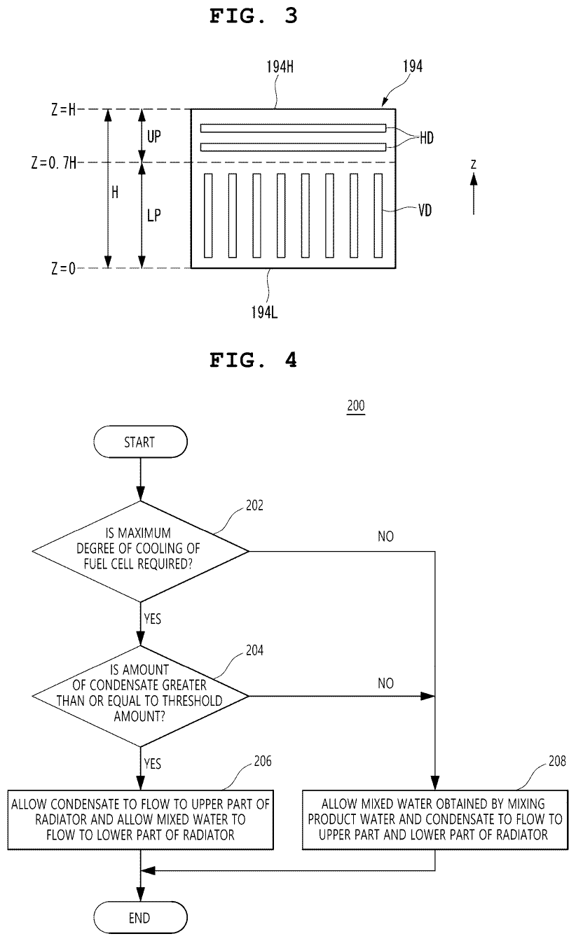

FIG. 3 is a front view of the radiator 194 shown in FIG. 2. As shown in FIG. 2, in the case in which the radiator 194 includes the first and second radiators RAD1 and RAD2, the front view illustrated in FIG. 3 corresponds to a front view of the first radiator RAD1.

Referring to FIG. 3, when viewed from the front, the radiator 194 may include an upper part UP and a lower part LP.

The upper part UP of the radiator 194 may be the entirety of the radiator 194 or may correspond to an area that is located from or includes 30% to 100% of the overall height H of the radiator 194. As illustrated in FIG. 3, the upper part UP of the radiator 194 may correspond to an (e.g., upper) area that is located or extends from 70% to 100% of the overall height H of the radiator 194.

Assuming that the coordinate of the bottom surface 194L of the radiator 194 in the z-axis direction (or the vertical direction) is “0” (z=0) and the coordinate of the top surface 194H of the radiator 194 in the z-axis direction (or the vertical direction) is “H” (z=H), the upper part UP of the radiator 194 may be defined as an area or portion of 0.7 H≤z≤H, and the lower part LP of the radiator 194 may be defined as an area or portion of 0≤z<0.7 H.

The first nozzle 162 allows the condensate W2 or the mixed water W4 to flow to the radiator 194 in the horizontal direction, and the second nozzle 164 allows the mixed water W4 to flow to the radiator 194 in the vertical direction.

In FIG. 3, an area of the radiator 194 extending in the horizontal direction in which the condensate W2 or the mixed water W4 is allowed to flow or travel (e.g., through the radiator 194) after being sprayed or dispensed by the first nozzle 162 is represented by “HD”. An area of the radiator 194 extending in the vertical direction in which the mixed water W4 is allowed to flow or travel (e.g., through the radiator 194) after being sprayed or dispensed by the second nozzle 164 is represented by “VD”.

Although two areas extending in the horizontal direction HDs are illustrated in FIG. 3, the embodiments are not limited thereto. The amount of heat generated by the radiator 194 and the number of areas extending in the horizontal direction HDs may be proportional to each other. If the radiator 194 generates a large amount of heat, the number of areas extending in the horizontal direction HDs may be increased, and if the radiator 194 generates a small amount of heat, the number of areas extending in the horizontal direction HDs may be reduced. The range of the upper part UP may be determined depending on the number of HDs. For example, if the number of areas extending in the horizontal direction HDs is greater than two, the upper part UP may correspond to an area that is located from less than 70% to 100% of the overall height H of the radiator 194.

According to an embodiment, the number of first nozzles 162 may be proportional to the amount of heat generated by the cell stack included in the fuel cell 110 and the length of the first nozzle(s) 162 may be proportional to the number of fins and tubes of the radiator 194. The number of second nozzles 164 may be proportional to the number of tubes of the radiator 194.

In addition, according to an embodiment, a distance between the nozzle 160 and the radiator 194 may be varied in response to a distance control signal DC output from the controller 180. In response to the distance control signal DC, a first distance D1 between the first nozzle 162 and the radiator 194 may be varied, and a second distance D2 between the second nozzle 164 and the radiator 194 may be varied.

Referring again to FIG. 2, the fuel cell vehicle 100 may further include first and second storage units 132 and 134 (e.g., first and second reservoirs or containers 132 and 134). The first storage unit 132 serves to store product water W1 discharged from the fuel cell 110. In addition, the second storage unit 134 may store condensate W2 generated by the condensate generation unit 120.

The fuel cell vehicle 100 according to the embodiment may further include a mixed water generation unit 140. The mixed water generation unit 140 may mix the product water W1 and the condensate W2 to generate mixed water W4 having a lower temperature than the product water W1 and a higher temperature than the condensate W2.

The mixed water generation unit 140 may include first and second valves (V1 and V2) 142 and 144 and a third storage unit 146 (e.g., third reservoir or container 134).

In response to a first valve control signal VC1 output from the controller 180, the first valve (V1) 142 regulates the flow rate of the product water W1 discharged from the first storage unit 132, and discharges the product water W1 to the third storage unit 146. In response to a second valve control signal VC2 output from the controller 180, the second valve (V2) 144 regulates the flow rate of the condensate W2 discharged from the second storage unit 134, and discharges the condensate W2 to the third storage unit 146.

The third storage unit 146 mixes the product water W1 having passed through the first valve (V1) 142 and the condensate W2 having passed through the second valve (V2) 144 to generate mixed water W4, and stores the mixed water W4.

The fuel cell vehicle 100 according to the embodiment may further include a third valve (V3) 136 and a fourth storage unit 138 (e.g., fourth reservoir or container 138).

The third valve (V3) 136 regulates the flow rate of the condensate W2 discharged from the second storage unit 134, and discharges the condensate W2 to the fourth storage unit 138.

The fourth storage unit 138 stores the condensate W2 having passed through the third valve (V3) 136.

The fuel cell vehicle 100 according to the embodiment may further include first and second sensors 172 and 174.

The first sensor 172 senses at least one of the temperature or the level of the mixed water W4 stored in the third storage unit 146, and outputs a result S1 of the sensing to the controller 180. The second sensor 174 senses at least one of the temperature or the level of the condensate W2 stored in the fourth storage unit 138, and outputs a result S2 of the sensing to the controller 180.

The controller 180 generates control signals (e.g., VC1, VC2, VC4, VC5, and PC) using a result of the sensing by at least one of the first sensor 172 or the second sensor 174. For example, upon determining, based on the result S1 of the sensing by the first sensor 172, that the temperature of the mixed water W4 stored in the third storage unit 146 is not an intermediate temperature between the temperature of the product water W1 and the temperature of the condensate W2, the controller 180 may control the flow rate of the product water W1 or the flow rate of the condensate W2 using the first and second valve control signals VC1 and VC2 so that the temperature of the mixed water W4 becomes an intermediate temperature between the temperature of the product water W1 and the temperature of the condensate W2.

According to an embodiment, the third storage unit 146 may be located at a higher or lower position than the nozzle 160.

If the third storage unit 146 is located at a higher position than the nozzle 160, the fuel cell vehicle 100 according to the embodiment may further include a fourth valve (V4) 152 that discharges the mixed water W4 stored in the third storage unit 146 to the nozzle 160. In this way, if the third storage unit 146 is located at a higher position than the nozzle 160, the liquid may fall from the third storage unit 146 to the nozzle 160 due to gravity, and thus a pump PM is not necessary.

On the other hand, if the third storage unit 146 is located at a position which is lower than the nozzle 160, the fuel cell vehicle 100 according to the embodiment may further include a pump PM in place of the fourth valve (V4) 152. The pump (PM) 152 serves to pump and discharge the mixed water W4 stored in the third storage unit 146 to the nozzle 160. For example, the pump PM may be an electric water pump (EWP).

In addition, if the fourth storage unit 138 is located at a position which is lower than the nozzle 160, the fuel cell vehicle 100 according to the embodiment may further include a pump that pumps and discharges the mixed water stored in the fourth storage unit 138 to the nozzle 160.

In addition, the fuel cell vehicle 100 may further include a fifth valve (V5) 154. The fifth valve (V5) 154 serves to allow or interrupt the supply of the condensate stored in the fourth storage unit 138 to the nozzle 160, i.e., the first nozzle 162.

The controller 180 may control opening/closing of the fourth valve V4 or the pump (PM) 152 and the fifth valve (V5) 154. Accordingly, the controller 180 may control the flow rate(s) through the fourth valve V4 or the pump (PM) 152 and the fifth valve (V5) 154.

In response to the fourth valve control signal VC4 output from the controller 180, the fourth valve (V4) 152 may regulate the flow rate of the mixed water W4 discharged from the third storage unit 146, and may supply the mixed water W4 to the nozzle 160. In this case, in response to the fourth valve control signal VC4, the fourth valve (V4) 152 may discharge the mixed water W4 to each of the first and second nozzles 162 and 164 or may discharge the mixed water W4 only to the second nozzle 164.

In addition, in response to the pump control signal PC output from the controller 180, the pump (PM) 152 may regulate the flow rate of the mixed water W4 discharged from the third storage unit 146, and may pump and supply the mixed water W4 to the nozzle 160. In this case, in response to the pump control signal PC, the pump (PM) 152 may discharge the mixed water W4 to each of the first and second nozzles 162 and 164 or may discharge the mixed water W4 only to the second nozzle 164.

In addition, in response to the fifth valve control signal VC5 output from the controller 180, the fifth valve (V5) 154 may regulate the flow rate of the condensate W2 discharged from the fourth storage unit 138, and may supply the condensate W2 to the first nozzle 162. The fifth valve (V5) 154 may allow or interrupt the supply of the condensate W2 to the first nozzle 162 in response to the fifth valve control signal VC5.

In addition, the fuel cell vehicle 100 according to the embodiment may further include a third sensor 176. The third sensor 176 may be disposed between the radiator 194 and the fan 196 to sense the amount of water (e.g., product water W1, condensate W2, and/or mixed water W4) having passed through the radiator 194 and output a result S3 of the sensing to the controller 180. The controller 180 may control the RPM of the fan 196 through the fan driving unit 178 using the result S3 of the sensing by the third sensor S3 or the distances D1 and D2 between the nozzle 160 and the radiator 194.

As shown in FIG. 2, if the radiator 194 includes the first and second radiators RAD1 and RAD2, the third sensor 176 may be disposed between the second radiator RAD2 and the fan 196.

The controller 180 may generate the control signals (e.g., VC4, PC, and VC5) in accordance with the degree of cooling required for the fuel cell 110.

Hereinafter, a method 200 of cooling the fuel cell vehicle according to an embodiment is described with reference to the accompanying drawings.

FIG. 4 is a flowchart for explaining a method 200 of cooling the fuel cell vehicle according to an embodiment.

For convenience of description, the method 200 shown in FIG. 4 is described as being performed by the fuel cell vehicle 100 shown in FIG. 2; however, the embodiments of the present disclosure are not limited thereto. The method 200 shown in FIG. 4 may be performed by a vehicle configured differently from the fuel cell vehicle 100 shown in FIG. 2. The fuel cell vehicle 100 shown in FIG. 2 may be cooled by a method configured differently from the method 200 shown in FIG. 4.

Steps 202 and 204 shown in FIG. 4 may be performed by the controller 180, and steps 206 and 208 may be performed under the control of the controller 180.

First, whether a maximum degree of cooling of the fuel cell 110 (hereinafter referred to as “intensive cooling”) is required is determined (step 202). If the fuel cell vehicle 100 is driven at a high speed or on a hill, it may be determined that a maximum degree of cooling of the fuel cell 110 is required. To this end, the controller 180 may analyze the driving state of the fuel cell vehicle.

In the intensive cooling mode, i.e., if the degree of cooling required for the fuel cell 110 is maximum or above a threshold, whether the amount of condensate W2 is greater than or equal to a threshold amount is determined (step 204). As described above, the amount of condensate W2 is smaller than the amount of product water W1 (e.g., less condensate W2 is generated than product water W1 is discharged), and thus whether the amount of condensate W2 is sufficient is determined in step 204. Here, the threshold amount may be set in advance or may be varied depending on the amount of condensate W2 stored in the fourth storage unit 138.

If the amount of condensate W2 is greater than or equal to the threshold amount, the condensate W2 is allowed to flow (e.g., provided) to the upper part UP of the radiator 194, and the mixed water W4 is allowed to flow (e.g., provided) to the lower part LP of the radiator 194 (step 206).

In order to perform step 204, the controller 180 may check the level of the condensate W2 stored in the fourth storage unit 138, sensed by the second sensor 174, and may determine whether the amount of condensate W2 is greater than or equal to the threshold amount.

In order to perform step 206, if the amount of condensate W2 is greater than or equal to the threshold amount, the controller 180 controls the fifth valve (V5) 154 through the fifth valve control signal VC5 to supply the condensate W2 stored in the fourth storage unit 138 to the first nozzle 162. In this case, the controller 180 controls the fourth valve (V4) 152 through the fourth valve control signal VC4 to supply the mixed water W4 stored in the third storage unit 146 to the second nozzle 164. Alternatively, the controller 180 controls the pump (PM) 152 through the pump control signal PC to supply the mixed water W4 stored in the third storage unit 146 to the second nozzle 164.

In this case, the first nozzle 162 allows the condensate W2 to flow, for example, spraying or dispensing the condensate W2 on to the upper part UP of the radiator 194, such that the condensate water W2 may flow or travel through the (e.g., open) areas extending in the horizontal direction HD of the radiator 194. Further, in this case, the second nozzle 164 allows the mixed water W4 to flow, for example, spraying or dispensing the mixed water on to the lower part LP of the radiator 194, such that the mixed water W4 may flow or travel through the (e.g., open) areas extending in the vertical direction VD of the radiator 194.

In some cases, step 204 may be omitted. In this case, if the degree of cooling required for the fuel cell 110 is maximum, step 206 is performed.

On the other hand, if the degree of cooling required for the fuel cell 110 is less than the maximum (hereinafter referred to as “general cooling”) or if the amount of condensate W2 is less than the threshold amount, the mixed water W4 in which the product water W1 and the condensate W2 are mixed is allowed to flow, for example, is sprayed or dispensed to each of the upper part UP and the lower part LP of the radiator 194 (step 208).

In order to perform step 208, when the fuel cell vehicle 100 is neither driven at a high speed (e.g., is driven at a low or constant speed) nor on a hill, i.e., in the general cooling mode, the controller 180 controls the fifth valve (V5) 154 through the fifth valve control signal VC5 to prevent the condensate W2 stored in the fourth storage unit 138 from being supplied to the first nozzle 162. In this case, the controller 180 controls the fourth valve (V4) 152 through the fourth valve control signal VC4 to supply the mixed water W4 stored in the third storage unit 146 to each of the first and second nozzles 162 and 164. Alternatively, the controller 180 controls the pump (PM) 152 through the pump control signal PC to supply the mixed water W4 stored in the third storage unit 146 to each of the first and second nozzles 162 and 164.

In this case, the first nozzle 162 allows the mixed water W4 to flow, for example, spraying or dispensing the mixed water W4 on to the upper part UP of the radiator 194, such that the mixed water W4 may flow or travel through the (e.g., open) areas extending in the horizontal direction HD of the radiator 194. Further, in this case, the second nozzle 164 allows the mixed water W4 to flow, for example, spraying or dispensing the mixed water W4 on to the lower part LP of the radiator 194, such that the mixed water W4 may flow or travel through the (e.g., open) areas extending in the vertical direction VD of the radiator 194.

After at least one of the condensate W2 or the mixed water W4 flows to or through the radiator 194, the third sensor 176 senses the amount of water having passed through the radiator 194, and outputs a result S3 of the sensing to the controller 180.

Based on the result of the sensing by the third sensor 176, upon determining that the amount of water having passed through the radiator 194 is large, the controller 180 may lower the RPM of the fan 196, and upon determining that the amount of water having passed through the radiator 194 is small, the controller 180 may raise the RPM of the fan 196. In this way, the controller 180 may control the rotational speed (RPM) of the fan 196 in inverse proportion to the amount of water having passed through the radiator 194.

For example, when the RPM of the fan 196 is high, water may pass through the radiator 194 without sticking to the surface of the radiator 194, and thus the amount of water sensed by the third sensor 176 may be large. When the amount of water sensed by the third sensor 176 is large, the RPM of the fan 196 may be lowered, thereby allowing a large amount of water to stick to the surface of the radiator 194.

Hereinafter, the fuel cell vehicle and the method of cooling the same according to the embodiments are described in comparison with a comparative example.

According to a fuel cell vehicle and a method of cooling the same according to a comparative example, product water of a fuel cell is sprayed to the surface of a radiator in a circular form through a nozzle. In this case, the product water does not completely touch or come into contact with the entire surface of the radiator. Thus, the heat exchange efficiency of the radiator may deteriorate as compared to if the product water came into contact with entire surface of the radiator.

In contrast, according to the fuel cell vehicle and the method of cooling the same according to the embodiments of the present disclosure, the mixed water W4 in which the product water W1 and the condensate W2 are mixed is allowed to flow to the upper part UP and the lower part LP of the radiator 194. Alternatively, the condensate W2 is allowed to flow to the upper part UP of the radiator 194, and the mixed water W4 is allowed to flow to the lower part LP of the radiator 194. In this way, because water is allowed to flow or be provided separately to discrete portions of the radiator and so as to flow or be provided to the entire radiator 194 rather than being sprayed generally toward or onto the surface of the radiator 194, heat exchange may occur over the entire surface of the radiator 194 without any dead zone(s). Accordingly, the effect or efficiency of cooling the radiator 194 may be improved.

In addition, according to the embodiments of the present disclosure, in the intensive cooling mode, the condensate W2 having a lower temperature than the product water W1 or the mixed water W4 is allowed to flow to the upper part UP of the radiator 194, which generates a large amount of heat, thereby maximizing cooling efficiency. Further, in the general cooling mode, because the amount of heat generated from the fuel cell 110 is not large, the mixed water W4, rather than the condensate W2, is allowed to flow to the entire surface of the radiator 194. Accordingly, it may be possible to efficiently use the condensate W2, the amount of which is smaller than that of product water W1.

As a result, according to the embodiment, the efficiency of cooling the fuel cell 110 may be improved without increasing the number of radiators 194 or the number of fans 196, whereby consumption of electricity from the fuel cell 110, i.e., efficiency of use of electricity, may be improved.

As is apparent from the above description, according to a fuel cell vehicle and a method of cooling the same according to embodiments of the present disclosure, because water is allowed to flow or be provided to an entirety of the radiator rather than being sprayed generally toward or to the surface of the radiator, heat exchange may occur over the entire surface of the radiator without a dead zone. Accordingly, the effect of cooling the radiator may be improved. In an intensive cooling mode, condensate having a lower temperature than product water or mixed water is allowed to flow to an upper part of the radiator, which generates a large amount of heat, thereby maximizing cooling efficiency. Further, in a general cooling mode, because the amount of heat generated from a fuel cell is not large, the mixed water, rather than the condensate, is allowed to flow to the entire surface of the radiator. Accordingly, it may be possible to efficiently use the condensate, the amount of which is smaller than that of product water. As a result, the efficiency of cooling the fuel cell may be improved without increasing the number of radiators or the number of fans, whereby consumption of electricity from the fuel cell, i.e., efficiency of use of electricity, may be improved.

However, the effects achievable through the disclosure are not limited to the above-mentioned effects, and other effects not mentioned herein should be clearly understood by those of ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to embodiments thereof, these embodiments are only proposed for illustrative purposes, and do not restrict or limit the present disclosure. It should be apparent to those of ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell vehicle, comprising:
a fuel cell including a cell stack configured to discharge product water as a by-product of power generation;
a condensate generation unit configured to generate condensate having a lower temperature than the product water;
a radiator configured to dissipate heat from cooling water having cooled the fuel cell;
a nozzle configured to allow at least one of the product water, the condensate, or mixed water obtained by mixing the product water and the condensate to flow to the radiator in response to a control signal; and
a controller configured to generate the control signal in accordance with a degree of cooling required for the fuel cell.

2. The fuel cell vehicle according to claim 1, wherein the nozzle includes:
a first nozzle configured to allow the condensate or the mixed water to flow to an upper part of the radiator; and
a second nozzle configured to allow the mixed water to flow to a lower part of the radiator.

3. The fuel cell vehicle according to claim 2, wherein the upper part of the radiator corresponds to an area of the radiator including 30% to 100% of an overall height of the radiator.

4. The fuel cell vehicle according to claim 2, wherein the first nozzle allows the condensate or the mixed water to flow through an open area of the radiator extending in a horizontal direction, and
wherein the second nozzle allows the mixed water to flow through an open area of the radiator extending in a vertical direction.

5. The fuel cell vehicle according to claim 2, wherein the first nozzle includes one or more first nozzles based on an amount of heat generated from the cell stack,
wherein the one or more first nozzles have a length proportional to a number of fins and a number of tubes of the radiator, and
wherein the second nozzle includes one or more second nozzles based on the number of tubes of the radiator.

6. The fuel cell vehicle according to claim 2, further comprising:
a first reservoir configured to store the product water; and
a second reservoir configured to store the condensate.

7. The fuel cell vehicle according to claim 6, further comprising a mixed water generation unit configured to mix the product water and the condensate to generate the mixed water having a lower temperature than the product water and a higher temperature than the condensate.

8. The fuel cell vehicle according to claim 7, wherein the mixed water generation unit includes:
a first valve configured to regulate a flow rate of the product water discharged from the first reservoir;
a second valve configured to regulate a flow rate of the condensate discharged from the second reservoir; and
a third reservoir configured to store, as the mixed water, water obtained by mixing the product water having passed through the first valve and the condensate having passed through the second valve.

9. The fuel cell vehicle according to claim 8, further comprising:
a third valve configured to regulate a flow rate of the condensate discharged from the second storage unit; and
a fourth reservoir configured to store the condensate having passed through the third valve.

10. The fuel cell vehicle according to claim 9, further comprising:
a first sensor configured to sense at least one of a temperature or a level of the mixed water stored in the third reservoir; and
a second sensor configured to sense at least one of a temperature or a level of the condensate stored in the fourth reservoir,
wherein the controller generates the control signal using a result of sensing by at least one of the first sensor or the second sensor.

11. The fuel cell vehicle according to claim 8, wherein the third reservoir is located at a higher position than the nozzle, and
wherein the fuel cell vehicle further includes a fourth valve configured to discharge the mixed water stored in the third reservoir to the nozzle.

12. The fuel cell vehicle according to claim 8, wherein the third reservoir is located at a lower position than the nozzle, and
wherein the fuel cell vehicle further includes a pump configured to discharge the mixed water stored in the third reservoir to the nozzle.

13. The fuel cell vehicle according to claim 9, wherein the fourth reservoir is located at a lower position than the nozzle, and
wherein the fuel cell vehicle further includes a pump configured to discharge the mixed water stored in the fourth reservoir to the nozzle.

14. The fuel cell vehicle according to claim 9, further comprising a fifth valve configured to allow or interrupt supply of the condensate stored in the fourth reservoir to the nozzle.

15. The fuel cell vehicle according to claim 1, further comprising:
a fan configured to control at least one of an air flow to the radiator or an air flow from the radiator; and
a third sensor disposed between the radiator and the fan, the third sensor being configured to sense an amount of the product water, condensate, or mixed water having passed through the radiator,
wherein the controller controls revolutions per minute of the fan using a result of sensing by the third sensor.

16. The fuel cell vehicle according to claim 15, wherein the radiator includes:
a first radiator; and
a second radiator disposed behind the first radiator, and
wherein the third sensor is disposed between the second radiator and the fan.

17. The fuel cell vehicle according to claim 15, further comprising a condenser disposed in front of the radiator.

18. A method of cooling a fuel cell vehicle comprising a fuel cell configured to discharge product water as a by-product of power generation, a condensate generation unit configured to generate condensate having a lower temperature than the product water, and a radiator configured to dissipate heat from cooling water having cooled the fuel cell, the method comprising:
providing mixed water obtained by mixing the product water and the condensate to an upper part and a lower part of the radiator based on a degree of cooling required for the fuel cell being less than a maximum degree; and
providing the condensate to the upper part of the radiator and providing the mixed water to the lower part of the radiator based on the degree of cooling required for the fuel cell being a maximum degree.

19. The method according to claim 18, wherein the mixed water or the condensate is provided to the upper part of the radiator so as to travel through an open area extending in a horizontal direction, and
wherein the mixed water is provided to the lower part of the radiator so as to travel through an open area extending in a vertical direction.

20. The method according to claim 18, wherein the fuel cell vehicle further includes a fan configured to control at least one of an air flow to the radiator or an air flow from the radiator, and
wherein the method further includes controlling revolutions per minute of the fan in inverse proportion to an amount of product water, condensate, and mixed water having passed through the radiator.

21. The method according to claim 18, wherein, based on the fuel cell vehicle being driven at a high speed or on a hill, the degree of cooling required is determined to be the maximum degree.

22. The method according to claim 18, further comprising:
determining whether an amount of the condensate is greater than or equal to a threshold amount based on the degree of cooling required for the fuel cell being the maximum degree;
providing the mixed water to the upper part of the radiator based on the amount of the condensate being less than the threshold amount; and
providing the condensate to the upper part of the radiator based on the amount of the condensate being greater than or equal to the threshold amount.
